(19) United States
(12) Patent Application Publication
(10) Pub. No.: US 2014/0165586 A1
(43) Pub. Date: Jun. 19, 2014

(54) TURBINE START METHOD

(71) Applicant: United Technologies Corporation, (US)

(72) Inventor: David L. Ripley, San Diego, CA (US)

(73) Assignee: UNITED TECHNOLOGIES CORPORATION, Hartford, CT (US)

(21) Appl. No.: 13/716,243

(22) Filed: Dec. 17, 2012

(51) Int. Cl. F02C 7/26

(52) U.S. Cl. CPC F02C 7/26
USPC 60/778; 60/788

(57) ABSTRACT

A method of starting an engine includes the steps of starting a fuel supply pump, opening a fuel solenoid to allow fuel flow to a combustor to at least partially begin, and beginning to operate a starter motor to drive a shaft associated with the engine. Then an ignitor is excited to spark in the combustor. An engine is also disclosed.

### STATEMENT REGARDING FEDERALLY SPONSORED RESEARCH OR DEVELOPMENT

This invention was made with government support under Contract No. N0001906-C-0081 awarded by the United States Navy. The Government has certain rights in this invention.

### BACKGROUND OF THE INVENTION

This application relates to a method of starting an engine.

Gas turbine engines are known and typically include a compressor compressing air and delivering it into a combustor. The air is mixed with fuel in the combustor and ignited. Products of this combustion pass downstream over a turbine rotor, driving the turbine rotor to rotate. The turbine rotor in turn rotates the compressor rotor.

One particular type of gas turbine engine is an auxiliary power unit (“APU”). The APU has the basic components mentioned above. Typically, to start an APU, a starter motor begins to drive the turbine, and the compressor rotors. This delivers air into the combustion section. At some percentage of operating speed, an ignitor is excited, and fuel is delivered into the combustor. There is a small window of speed at which ignition is most likely to occur, i.e. a “light-off” window.

The conventional start method generally takes the following steps, in this order. A start command is sent to an APU controller, which issues a start command to a starter motor. The starter motor begins to drive the compressor and turbine rotor. At approximately 3% of operational speed, an exciter is turned on to cause at least one ignitor to spark.

Typically the APU fuel valve is opened at the same time, or soon after, the ignitor is energized. When the valve is opened, fuel flows to the APU's fuel nozzles and into the combustor. Initially during start there is a lag before the fuel fills the fuel manifolds and reaches the combustor. If the APU accelerates quickly APU speed may be considerable greater than 3% before fuel reaches the combustor. If APU speed is too high before fuel is delivered, the APU may fail to light. With this method, ignition has not been as reliable as would be desired.

### SUMMARY OF THE INVENTION

In a featured embodiment, a method of starting an engine includes the steps of allowing a combustor to at least partially fill before ignition is commanded, beginning to operate a starter motor to drive a shaft associated with the APU, and then exciting an ignitor to spark in the combustor.

In another embodiment according to the previous embodiment, there is a delay after beginning to allow a combustor to at least partially fill before ignition is commanded, and before beginning to operate a starter motor to drive a shaft associated with the APU.

In another embodiment according to any of the previous embodiments, the delay between beginning to allow a combustor to at least partially fill before ignition is commanded and beginning step to operate a starter motor to drive a shaft associated with the APU is at least equal to one second.

In another embodiment according to any of the previous embodiments, the delay is between one second and 10 seconds.

In another embodiment according to any of the previous embodiments, beginning to allow a combustor to at least partially fill before ignition is commanded, and beginning to operate a starter motor to drive a shaft associated with the APU occur simultaneously.

In another embodiment according to any of the previous embodiments, the ignitor is excited to spark when the shaft reaches at least equal to 3% of the normal operational speed of the APU.

In another embodiment according to any of the previous embodiments, the ignitor is sparked when the shaft speed reaches a light-off window range of equal to or between 3 and 9% of the normal operational speed of the APU.

In another embodiment according to any of the previous embodiments, the partial filling of the combustor occurs into a fuel manifold.

In another embodiment according to any of the previous embodiments, the engine is an auxiliary power unit.

In another featured embodiment, an engine has a fuel supply pump for delivering fuel into a combustor for combustion. The combustor is configured to drive a turbine which is configured to drive a shaft. A starter motor drives the shaft. A fuel solenoid upstream of the combustor delivers fuel into the combustor. An ignitor is included. A controller for the APU is configured to operate the engine at start up by starting the fuel supply pump to allow the fuel to flow towards the combustor, beginning to operate the starter motor to drive the shaft, and then exciting the ignitor to spark in the combustor.

In another embodiment according to the previous embodiment, there is a delay between the start of the fuel supply pump, and the beginning of operation of the starter motor.

In another embodiment according to any of the previous embodiments, the delay between beginning to allow a combustor to at least partially fill before ignition is commanded, and beginning to operate a starter motor to drive a shaft associated with the APU is at least equal to one second.

In another embodiment according to any of the previous embodiments, the delay is between one second 10 seconds.

In another embodiment according to any of the previous embodiments, beginning to allow a combustor to at least partially fill before ignition is commanded, and beginning to operate a starter motor to drive a shaft associated with the APU begin to occur simultaneously.

In another embodiment according to any of the previous embodiments, the ignitor is excited to spark when the shaft reaches at least equal to 3% of the normal operational speed of the APU.

In another embodiment according to any of the previous embodiments, the ignitor is sparked when the shaft speed reaches a light-off window range of equal to or between 3 and 9% of the normal operational speed of the APU.

In another embodiment according to any of the previous embodiments, the partial filling of the combustor occurs into a fuel manifold.

In another embodiment according to any of the previous embodiments, the engine is an auxiliary power unit.

These and other features may be best understood from the following drawings and specification. The following which is a brief description.

### BRIEF DESCRIPTION OF THE DRAWINGS

FIG. 1 schematically shows an APU.

FIG. 2 is a flow chart of a method of starting an APU.

### DETAILED DESCRIPTION

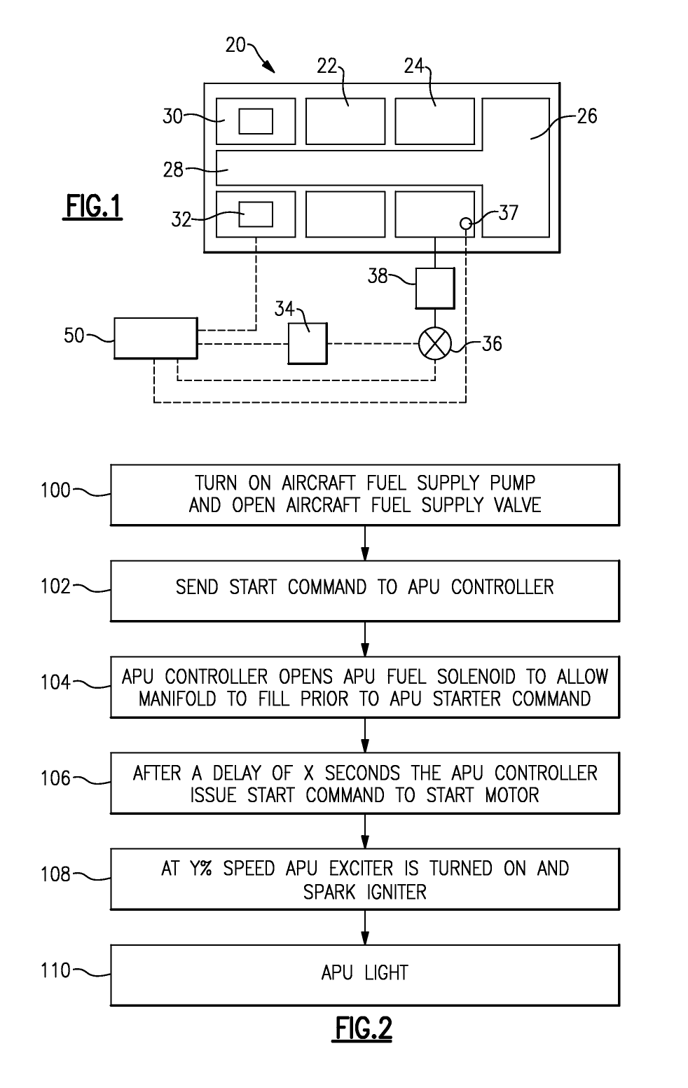

FIG. 1 shows an APU 20 having a compressor rotor 22 for delivering compressed air into a combustion section 24. The air is mixed with fuel in the combustion section 24 and ignited. Products of the combustion pass downstream over a turbine rotor 26 causing it to rotate. This is a very simplified explanation of an APU, and, in other embodiments, there may be more than one compressor and more than one turbine rotor as would be understood by those of ordinary skill in the art.

The turbine rotor 26 drives a shaft 28 to in turn drive the compressor rotor 22. The shaft 28 is typically engaged with a gear box 30 to drive several accessories associated with the gas turbine engine. A starter motor 32 is also selectively connected to the shaft 28 through the gear box 30. At start up, the starter motor 32 is energize to begin driving the shaft 28, and thus the compressor rotor 22 and turbine rotor 26.

A controller 50 for the APU controls the starter motor 32, a fuel pump and fuel valve 34, a fuel solenoid 36, and an ignitor 37.

In an embodiment, the controller 50 ensures that there will be adequate fuel available when the ignitor 37 is excited.

Thus, in a method of operating the APU 20 as shown in FIG. 1, and as described in the flow chart of FIG. 2, the fuel supply pump 34 is started, and an aircraft fuel supply valve is opened at block 100. A start command is sent to the APU controller 50 at block 102. The APU controller 50 opens an APU fuel solenoid 36 to allow a manifold 38 to be at least partially filled prior to the beginning of operation of a starter motor 32 at block 104.

While a manifold 38 is disclosed as the location of the prefilled fuel, other portions of the combustor could also receive the fuel. For purposes of this application, the term “combustor” would include not only a chamber within the combustor, but also a manifold.

After a delay of x seconds, the APU controller 50 issues a start command to the start motor 32 and the start motor 32 begins to drive the shaft 28 at block 106. Once the shaft 28 reaches a speed of y percent of the operational speed of the APU, the exciter 37 is turned on at block 108, and an ignitor sparks causing ignition at block 110. Given that the fuel will be prefilled into the manifold 38, ignition will occur at a lower speed than would be otherwise possible and would be more reliable than with the prior art method.

In embodiments, the time x is at least equal to one second and typically would be equal to or between one and ten seconds depending on manifold fill volume and available supply pressure. The window y is generally on the order of equal to or between 3-9% of the normal operational speed of the APU but can vary outside these limits depending on installed conditions.

In a distinct embodiment, there is no delay of x seconds between opening the fuel solenoid 36, and beginning operation of the starter motor 32. The two may begin to occur simultaneously, as long as there is sufficient time for the prefill of the combustor to occur. In fact, it may also be possible for the starter motor to begin operation prior to the beginning of the supply of fuel. In general, the fuel solenoid 36 must be opened before the shaft 28 reaches the speed y.

While this application specifically discloses an APU 20, its teachings may extend to other types of gas turbine engines, such as aviation engines, or ground-based power supply engines.

Although an embodiment of this invention has been disclosed, a worker of ordinary skill in this art would recognize that certain modifications would come within the scope of this invention. For that reason, the following claims should be studied to determine the true scope and content of this invention.

1. A method of starting an engine comprising the steps of:
(a) allowing a combustor to at least partially fill before ignition commanded;
(b) beginning to operate a starter motor to drive a shaft associated with the APU; and
(c) then exciting an ignitor to spark in the combustor.

2. The method as set forth in claim 1, wherein there is a delay after the beginning of step (a) and prior to the beginning of step (b).

3. The method as set forth in claim 2, wherein the delay between beginning step (a) and beginning step (b) is at least equal to one second.

4. The method as set forth in claim 3, wherein the delay is between one second and 10 seconds.

5. The method as set forth in claim 1, wherein steps (a) and (b) begin to occur simultaneously.

6. The method as set forth in claim 1, wherein the ignitor is excited to spark when the shaft reaches at least equal to 3% of the normal operational speed of the APU.

7. The method as set forth in claim 6, wherein the ignitor is sparked when the shaft speed reaches a light-off window range of equal to or between 3 and 9% of the normal operational speed of the APU.

8. The method as set forth in claim 1, wherein the partial filling of the combustor occurs into a fuel manifold.

9. The method as set forth in claim 1, wherein the engine is an auxiliary power unit.

10. An engine comprising:
a fuel supply pump for delivering fuel into a combustor for combustion, the combustor configured to drive a turbine which is configured to drive a shaft;
a starter motor for driving the shaft;
a fuel solenoid upstream of the combustor for delivering fuel into the combustor;
an ignitor; and
a controller for the APU, the controller configured to operate the engine at start up by starting the fuel supply pump, to allow the fuel to flow towards the combustor, beginning to operate the starter motor to drive the shaft, and then exciting the ignitor to spark in the combustor.

11. The engine as set forth in claim 10, wherein there is a delay between the start of the fuel supply pump, and the beginning of operation of the starter motor.

12. The engine as set forth in claim 11, wherein the delay between beginning step (a) and beginning step (b) is at least equal to one second.

13. The engine as set forth in claim 12, wherein the delay is between one second 10 seconds.

14. The engine as set forth in claim 10, wherein steps (a) and (b) begin to occur simultaneously.

15. The engine as set forth in claim 10, wherein the ignitor is excited to spark when the shaft reaches at least equal to 3% of the normal operational speed of the APU.

16. The engine as set forth in claim 15, wherein the ignitor is sparked when the shaft speed reaches a light-off window range of equal to or between 3 and 9% of the normal operational speed of the APU.

17. The engine as set forth in claim 10, wherein the partial filling of the combustor occurs into a fuel manifold.

18. The engine as set forth in claim 10, wherein the engine is an auxiliary power unit.
